(19) United States
(12) Patent Application Publication
(10) Pub. No.: US 2010/0287382 A1
(43) Pub. Date: Nov. 11, 2010

(54) Two-factor graphical password for text password and encryption key generation

(75) Inventors: John Charles Gyorffy, Calgary (CA); James Miller, Edmonton (CA)

Correspondence Address: DOWELL & DOWELL P.C., 103 Oronoco St., Suite 220, Alexandria, VA, 22314, US

(73) Assignee: John Charles Gyorffy, Calgary, AB (CA)

(21) Appl. No.: 12/659,264

(22) Filed: Mar. 2, 2010

Related U.S. Application Data
(60) Provisional application No. 61/213,113, filed on May 7, 2009.

(51) Int. Cl. G06F 21/20; H04L 29/06

(52) U.S. Cl. 713/185; 726/9

(57) ABSTRACT

This invention details systems, methods, and devices for providing a two-factor graphical password system to a user so that the user may obtain access to a restricted resource. A first previously selected image (previously selected by the user) is presented to the user to enter his password by sequentially selecting predetermined areas on the first image. The user's input is used to create an encryption/decryption key which is used for communicating between a user application and a device. If the user has entered the correct password, then the device can communicate with the user application. Once the device can communicate with the user application, a second previously selected image (previously selected by the user) is presented to the user from the device. The user enters his second password and the user's input is sent to the device. The device then creates the user's alphanumeric password or another encryption key from the user's input and sends this to the user application. The user application then transmits the password or key to the system which restricts access to the restricted resource.

### FIELD OF THE INVENTION

The present invention relates to the provision of access provision means, such as passwords and encryption keys, to access restriction systems to gain access to restricted resources such as websites and computer networks. More specifically, the present invention relates to systems, devices, and methods for providing a graphical password system using a secure, useful form factor.

### BACKGROUND TO THE INVENTION

The communications and data processing revolution of the past few decades has led to an explosion in the use of devices and applications for restricting access to the fruits of these revolutions. The almost ubiquitous password screen now governs access to such restricted resources. Alphanumeric passwords are now required to gain access to everything from protected websites to computer networks, and even to the computers and data processing devices themselves.

The need to prevent access to such restricted resources has led to a similar rise in the mostly illegitimate need to bypass these access restriction systems. Access restriction systems, such as programs that require a password to proceed further or systems that require a specifically encrypted communications link to properly function, have been vulnerable to a number of attacks. Spyware programs, key-logging programs, and other nefarious pieces of software abound which try and steal passwords and other access provision means from legitimate users.

Two major problems in this field is the prevalence of key-logging spyware and the difficulty users have with creating high-entropic (hard-to-guess), alphanumeric passwords. Also, it is well-known that spyware can masquerade as legitimate software applications or infect other applications. Such spyware can snoop and steal relevant information from legitimate programs that seek to restrict access to these restricted resources.

One of the other major problems with passwords is the human element. As outlined by Sasse and Adams, the problem is that users might write down their password instead of memorizing it. Additionally, the user might verbally communicate their password when they should not. Lastly, users tend to pick passwords that they can remember; however, these passwords can be easy to guess with a common dictionary-style attack.

The field of graphical passwords offers fertile ground for development in providing a suitable password/access provision system. Because Trojan key-loggers are a real and significant problem, and because users often do not select long, random alphanumeric passwords, graphical passwords seem to offer a better solution. Graphical passwords can prevent key-loggers while the user inputs a password. Therefore, threats from spyware are reduced or eliminated. If users do not need a keyboard, key logging is impossible. Mouse logging and screen capturing can be reduced by techniques specific to the operating system. It has been shown that pictures are easier to remember then a series of unrelated text and numbers. However, alphanumeric passwords are used on almost all Web login pages. Therefore, it is possible to convert the output of a graphical password to a long and random alphanumeric password compatible with these login systems. That is, the user can remember an easy graphical password to generate a long high-entropic alphanumeric password that would be very hard to guess.

As with any field, at first glance graphical passwords may not be an ideal solution. Many advantages and weaknesses of graphical passwords have been explored. Click-based graphical passwords are based on recognition and cued recall whereas alphanumeric passwords provide no aid to memory; rather, alphanumeric password users start a secure login session by staring at an empty input field. Wiedenbeck et al. showed that click-based, or locimetric, password schemes, such as PassPoints, had a lower login error rate over time compared to alphanumeric passwords. However, PassPoints suffered from an extended learning phase and increased login time when compared to alphanumeric equivalents. The main difficulty in PassPoints was that users were not able to accurately recognize their click-points. In the extreme case, if a user had to find their click-point on a completely white screen, it would be extremely hard, if not impossible. On the other extreme, if the image has a lot of clutter or repeating objects, the user would find it difficult to remember the correct location. Therefore, the recall and mouse-click accuracy seem to be highly dependent on the image type.

Another possible problem with graphical passwords is the hot-spot issue. As demonstrated by Chiasson and Oorschot et al., users will tend to pick points that are easy to remember. The type of image highly influences this behaviour. As an example, in an image with text and prevalent light and dark areas, the text would generally be easy to find and remember compared to the darker areas of the image, especially if the text were centered about a prominent feature of the image. An attacker might suspect that the prominent feature of the image is a region of interest when guessing the user's password.

As noted above, Trojans and other viruses represent another danger to access restriction systems. Their main danger is their ability to attack user memory, data, or applications that can possibly lead to password theft. The use of such programs is more nefarious as their presence may not be detected until significantly after the damage has been done. Also, such programs may be configured to not just steal passwords but also to harm the user's computers.

There is therefore a need for a password or access provision system that is resistant to tampering, hacking, and to other types of intrusions which seek to illegitimately obtain access to a user's password. It is therefore an aim of the present invention to mitigate if not overcome the shortcomings of the prior art as mentioned above.

### SUMMARY OF INVENTION

The present invention provides systems, methods, and devices for providing a graphical password system to a user so that the user may obtain access to a restricted resource. A portable read-only device will store two graphical passwords and provide the means of generating the final alphanumeric password or encryption key. The user must use his/her unique device in order to generate the correct password. Therefore, the device and the graphical password comprise a two-factor authentication system: what you have in your possession and what you know.

The device first presents the user with a previously selected image (previously selected by the user from a family photo) as a way to secure communication with the device. The user's click-sequence and x-y coordinates are used to form an AES 256-bit key to encrypt further communication with the device. Once the device has accepted the first graphical password, the device presents the user with an embedded Web browser with special features allowing the user to create a text password from a second previously selected image (previously selected by the user from a family photo) that is stored encrypted in the device. To enter an alphanumeric password into a password field, the user clicks a special button on the browser which displays the second graphical password from the device. The user clicks on the correct sequence of circles over the image and the result is sent to the device. The device adds random numbers it stores in flash memory to the previous data sent from the client application (click-points, an image hash, and root URL) and hashes the sum in a 256-bit cryptographic hashing function (SHA-256) to generate a 32-byte value. The random values should be generated at the factory where the device was cast using a true random number generator. The quantity of random numbers can be from ten to fifty with each having a range of a two-byte integer. The 32-byte value from the SHA-256 hash is filtered to allow ASCII text that the password field will accept. The device sends the final alphanumeric password to the Web browser and the browser inserts the password into the password field without using the clipboard.

The user must display the second graphical password each time a password is needed, as no passwords are stored in the device. However, the device will store the random numbers it added to the SHA-256 hash function along with the URL so the correct alphanumeric password is generated if the correct graphical password is entered. The user can change the alphanumeric password simply by telling the device to change the random numbers it adds to the graphical password output. This way, the user can keep the same image and click-sequence (no need to remember a new graphical password) but generate a completely new alphanumeric password or encryption key. It would be impossible to generate the correct alphanumeric password using someone else's device since the images and random values are unique to that device. Hence, the device comprises one important element of a two-factor authentication scheme.

In a first aspect, the present invention provides a device for providing access to a restricted resource, the device comprising:
storage means for storing at least one user selected image
processor means for deriving at least one access provision means from a plurality of user selected inputs based on said at least one user selected image, said access provision means being for provision to an access restriction system, said access restriction system providing access to said restricted resource when a correct access provision means is provided to said access restriction system

wherein said access restriction system receives said access provision means through an application interface means for interfacing between said device to said access restriction system.

In a second aspect, the present invention provides an access provision system for providing an access provision means to an access restriction system, said access restriction system being for controlling access to a restricted resource, the access provision system comprising:
a storage means for storing at least two user selected images and a stored key
an initial image provision means for providing to a user application an initial image from said at least two user selected images
a decryption means for decrypting incoming data transmissions from said user application using said stored key, said incoming data transmissions being encrypted using a key derived from first user input based on said initial user selected image
encryption means for encrypting outgoing data transmissions for transmittal to said user application, said outgoing data transmissions being encrypted using said stored key
subsequent image provision means for providing to said user application at least one subsequent image from said at least two user selected images
derivation means for deriving said access provision means from subsequent user input received from said user application, said subsequent user input being based on said at least one subsequent image
coupling means for coupling said access provision means to said access restriction system through said user application

In a third aspect, the present invention provides a method for providing an access provision means to an access restriction system, the method comprising:

a) receiving a request for at least one initial user selected image from a user application
b) transmitting said at least one initial user selected image to said user application
c) receiving at least one encrypted communication from said user application, said at least one encrypted communication being encrypted using an encryption key derived from user input based on said at least one initial user selected image
d) decrypting said at least one encrypted communication from said user application using a stored encryption key and determining if said at least one encrypted communication is properly encrypted
e) in the event said at least one encrypted communication is not properly encrypted, preventing access by said user application to at least one subsequent user selected image
f) in the event said at least one encrypted communication is properly encrypted,
encrypting subsequent transmissions to said user application using said stored transmission key
decrypting subsequent transmissions from said user application using said stored encryption key, and
receiving a request from said user application for said at least one subsequent user selected image
   g) transmitting said at least one subsequent user selected image to said user application
   h) receiving user input from said user application, said user input being based on said at least one subsequent user selected image.
   i) deriving said access provision means from said user input
   j) transmitting said access provision means to said user application.

### BRIEF DESCRIPTION OF THE DRAWINGS

The invention will be described with reference to the accompanying drawings, wherein

FIG. 1 is a flowchart illustrating the steps in a method according to one aspect of the invention;

FIG. 2 is a block diagram of an overview of the operation of a system according to another aspect of the invention;

FIG. 3 is a sample screen shot of an image used for a graphical password;

FIG. 4 is the array structure of input collected from the user's password and image which is sent to the device where it is hashed with random numbers.

FIG. 5 is a sequence diagram illustrating the data being communicated between the user application and the USB device and with a resultant alphanumeric

FIG. 6 is a screenshot of a toolbar which may be used to access specific aspects of the invention;

FIG. 7 is a block diagram of the scheme used for user application to device communications;

FIG. 8 an overview of the action the device takes when the user application sends data via the file I/O subsystem.

FIG. 9 is an overview of the action the device takes when the user application reads data via the file I/O subsystem.

FIG. 10 is the data structure used when sending commands to the processor from the user application;

FIG. 11 is the data structure used when receiving commands from the device;

FIG. 12 shows how a number once used (nonce) is used in the system as a way to create random data packets during encryption.

FIG. 13 illustrates the steps taken when using the nonce to enhance the security of the system by deriving a nonce from un-tampered client application. A tampered client application cause the nonce generation to fail.

FIG. 14 illustrates the construction of a 256-byte AES key from the first graphical password which is used to encrypt communication with the device.

FIG. 15 is a flowchart showing what the device will do when it receives data from any file I/O write operation.

FIG. 16 is a map of the data storage on the device according to one embodiment of the invention;

FIG. 17 illustrates the interaction of the Atmel module with a prototype of the invention;

### DETAILED DESCRIPTION OF THE INVENTION

In one embodiment, the present invention takes the form of a USB device with its own processor and storage. The USB device can be coupled to the user computer by any known means and would provide the user with the password or key(s) required so that the user may gain access to the restricted resource. Details and rationale for the design decisions for this embodiment are provided below. It should, however, be noted that while this embodiment is that of a USB device, other embodiments may take other forms. The USB device functions (as set out below) may be executed by other devices coupled to a user data processing system other than coupled by the USB port. It should also be noted that while the embodiment discussed below focuses on providing a password or key for website authentication, the system may be adapted for use in providing access to other restricted resources such as computers, computer networks, databases, and other data related restricted resources.

The present invention operates by providing two levels of checking using graphical passwords. When the USB device is coupled to the user machine, it may automatically execute a user application which seeks to access the data stored on the USB device. The USB device's processor acts as a guardian, only providing access to the important data stored on the USB device (the user selected images) only after the user application has been authenticated.

To ensure that the user application, downloaded from the USB device and executed on the user machine, is free from infection or corruption, a number of methods may be used (see relevant sections below). However, while these methods may ensure the correctness and purity of the user application, these checks are not strictly necessary for a proper working of the invention. If these authentication methods are implemented, the method proper for providing the access provision means (either a password, an encryption key, or anything suitable for providing access to the user to a restricted resource such as a website or a computer) only proceeds once these authentication methods have been executed and satisfied.

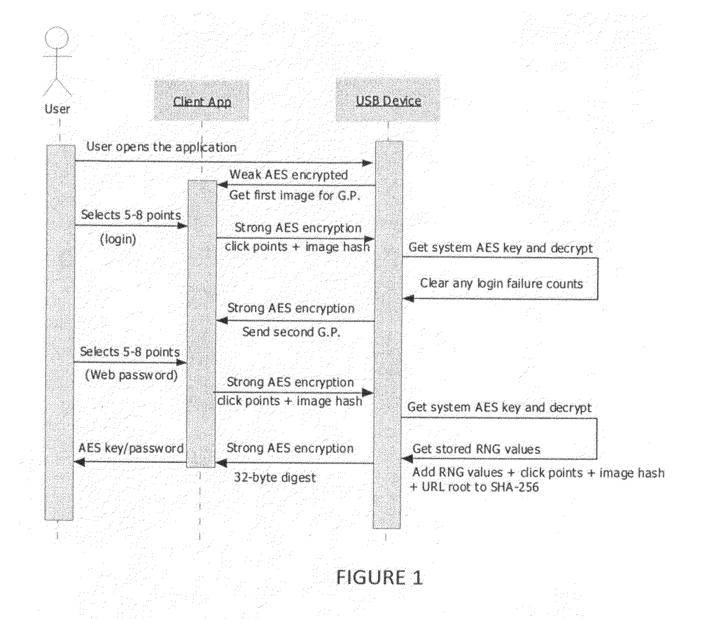

The method proper for providing the access provision means to the access restriction system starts with the USB device receiving communications from the user application. (See FIG. 1 flowchart) These communications are, preferably, encrypted using a weak encryption key that is shared between the USB device and the user application. The user application requests the first user selected image from the USB device. The USB device, once it has decrypted this request communication from the user application, encrypts the first image and sends it to the user application. The user application then decrypts the first image and presents it to the user with the predefined click or selection zones overlaid on the image.

Once the user has entered his or her input (by clicking on the appropriate selections zones or otherwise selecting the relevant selection zones), this input, along with any other required data, is then used to create/formulate a 256-bit AES encryption/decryption key to be used in communications between the user application and the USB device. With the encryption/decryption key created, this new key is used by the user application and device to encrypt/decrypt subsequent transmissions to each other including the rendering of the second graphical password image.

The USB device, once it receives these communications, then decrypts these communications using a stored encryption/decryption key. This stored encryption/decryption key, created and stored when the user sets up the USB device, should, ideally, be able to decrypt the communications from the user application. If the communications from the user application cannot be properly decrypted by the USB device, then the user has not entered the proper password/combination of clicked/selected selection zones in the first graphical password. If the device receives a predefined amount of illegal communication attempts, it self-destructs and becomes inoperable. If, on the other hand, these communications can be properly decrypted by the USB device, then this means that the encryption/decryption key created from the user's input is, depending on the encryption/decryption method used, either the same as or the matching pair of the encryption/decryption key stored in the USB device.

Once encrypted communications between the user application and the USB device is possible and has been established, all subsequent communications between these two are encrypted/decrypted using the stored key for the USB device and encrypted/decrypted using the created key for the user application.

With communications established, the user application then requests that the second user selected image be transmitted from the USB device. After receiving this request, the USB device then encrypts and transmits this second image to the user application. The user application then presents this second image to the user with, again, the predefined click or selection zones overlaid on the image. The user then enters his or her password in the same way as he or she entered his or her first password. The user input, with any relevant extra data, is then transmitted to the USB device using the same encryption/decryption key created by the user application as mentioned above.

The USB device receives this communication, with the user input, from the user application. The device then decrypts the communication and derives an access provision means from the contents of the decrypted communication. As noted before, the contents of the communications include the user input, in some form, as well as any extra data required by the implementation. The access provision means may be, depending on the implementation, a password, an encryption/decryption key, or a combination of both. This access provision means is then transmitted to the user application for passing on to the access restriction system or the system that requires a password or key to provide access to the restricted resource by the user.

Due to the prevalence of key-logging spyware and the difficulty users have with creating high-entropic, alphanumeric passwords, the present invention provides a novel graphical password scheme that generates highly entropic, long alphanumeric passwords. Given that spyware can masquerade as legitimate software applications or infect other applications, a read-only hardware system is required. A USB hardware system using secure file I/O offers such a solution. Most desktop and laptop computers using various operating systems support the USB port and file I/O; therefore, no special hardware or software drivers are needed to support this USB graphical password scheme. (Alternatively, a Bluetooth based device could be constructed for smart phones, etc.) Additionally, by using file I/O, most operating systems will not require the user to install any drivers or configure any settings, implying that the installation of the device requires no user involvement. The present invention combines the strength of graphical passwords with a low-cost USB hardware system to provide a secure way to generate strong alphanumeric passwords (or encryption keys).

Many weaknesses of graphical passwords have been explored. From these weaknesses a better click-based graphical password has been designed to eliminate hot-spots, guessing, and usability issues such as click-accuracy. By allowing the user to choose meaningful, family photos, or other images that they prefer, the issue of having a large database of copyright free images is resolved. Superimposed on the image, are randomly placed letters and numbers to form a virtual keypad (FIG. 3). This virtual keypad reduces the problem of users remembering the exact click-spot when they recall their password, as well as preventing key-logging spyware. The randomness of the x-y positions of letters and numbers on the underlying image reduces hot-spots. Additionally, the underlying image helps provide cued recall of the clicked password (as well as the entropy for the secure hash). As part of the implementation, persuasion is used to further randomize what a user can select for letters and numbers when creating a password. By requiring a family photo, or other desirable image, the probability of two users having the same photo is infinitesimal. The entropy of the image itself with the randomized virtual keypad superimposed on top will help form a cryptographic hash. The cryptographic hash will be used to generate either a 256-bit AES key for another secure layer of encryption more resistant to man-in-the-middle attacks or a 32-character alphanumeric password.

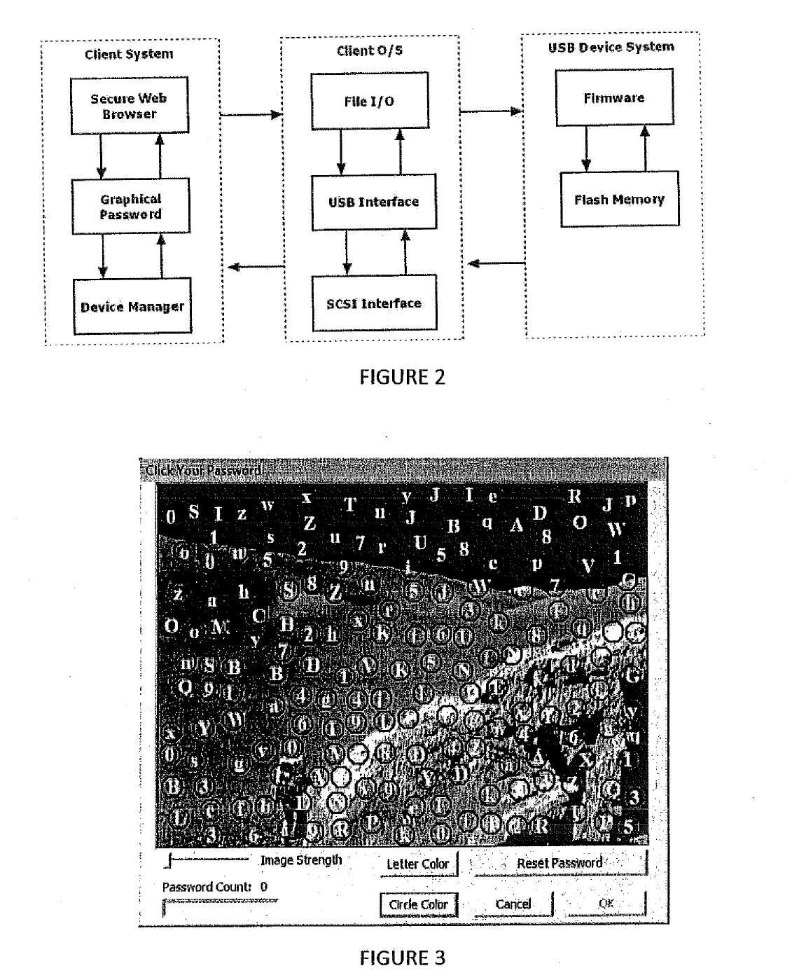

The danger of Trojans and other viruses is their ability to attack PC memory, data, or applications that can possibly lead to password theft. The present invention uses an embedded Web browser on a read-only USB device. With a read-only device, it is impossible to infect the firmware or firmware-protected flash memory. As far as the user is concerned, the USB device looks like a regular file system. The user will access the USB device like a normal file system and run a Web browser by double clicking on the executable program stored in the device's flash memory. When the Web browser is loaded from the USB device, a novel approach is used to validate that the binary image of the executable has not been infected or tampered with by malicious software as it passes through the file subsystem. All data transferred between the USB device and the user's PC is by file I/O using 256-bit AES encryption of all data. The encryption of data will depend on two graphical passwords. One graphical password will authenticate the user to the device and encrypt or decrypt data between the device and the main application. The other graphical password will be used to create a high-entropic, alphanumeric password or an AES key that can be used for an encrypted channel. The images will also help identify the device to the user, so they know if they are using the correct device before entering their password. FIGS. 1 and 2 provide diagrams of the overview of the operation of the system.

The present invention incorporates two graphical passwords into a secure web browser to make authentication simple and fast. The first graphical password is used to log the user into the USB device. The second graphical password is used in conjunction with the USB device to return either a long, random alphanumeric password or an AES encryption key for Web authentication. The Web browser also assists the user in initiating a secure login. That is, the final goal of the present invention is to provide a secure password which is more resistant to Trojans and password guessing than other available solutions. To provide this security, the main program (the user application) that the client uses is loaded from a read-only USB flash device. The USB device is controlled by a microcontroller that can verify and alter the data sent to the client system. One important module in the user application, called the Device Manager, handles communications with the USB device. The Device Manager uses a novel, secure way to transmit data on a USB bus using simple file input and output (I/O). Since most operating systems support a USB port and block file I/O with a storage device, the user need not install any drivers to use the USB device. An overview of the system is illustrated in FIG. 7.

The present invention is a locimetric scheme (uses clickable zones over the image) that uses an image of the user's choice. Because the image seems to be the main reason for varying login success and mouse-click accuracy, this scheme will moderate the importance of the image and provide randomly located, well demarcated click-points that the user can easily recognize. By using well demarcated areas, the user will not have to guess the tolerance and suffer from mouse-click inaccuracy. Additionally, in each demarcated area, a random letter or number will be placed. Because users are transitioning from a keyboard and alphanumeric passwords, putting letters and numbers over the image is likely to help with recall, especially if mnemonics are used. The image underneath the text will help aid in cued recall; however, since the user can also remember the text, the image does not have to be restricted to ones that offer the most memorable zones. Additionally, by allowing the user to choose a photo of their choosing, the user can pick one which is believed to assist with recall. Therefore, the system proposed is a hybrid of an alphanumeric password and a graphical password.

FIG. 3 illustrates a screen shot of what the user would be presented with. As can be seen from FIG. 3, the user merely has to select his or her password from the various predefined and predetermined areas in the figure (randomly predefined by the USB device when setting up the graphical password for the first time). While a mouse click would be ideal for such an implementation, other implementations which do not require a free-form pointing device may also be used; however, the radius of the demarcated zones may need to be enlarged.

Referring to FIG. 3, if one uses the same image and tolerance as PassPoints, the image is restricted to 451×331 with a click-point radius of 10 pixels. A circle is used to demarcate the allowed clickable location to the user. The user also has the ability to change the circle color or text color to allow for better contrast against the image. Additionally, the image intensity can be reduced, on a graduated scale, so the user can see the text better if required.

Regarding the amount of possible passwords for the system, the password space is determined by how many click-points are allowed on an image. Additionally, the quantity of letters or numbers in each circle should be a multiple of 4, as will be discussed. Given the image size, it was found that 180 points, with a 10 pixel radius, provided the optimal fit. The user will be required to pick at least 5 points resulting in a password space of: 180⁵ or 1.9×10¹¹. However, if the user were required to pick an 8-character alphanumeric password, the password space would increase to 180⁸ or 1.1×10¹⁸ possible choices. In contrast, an 8-character alphanumeric password only has 2.8×10¹⁴ possible choices using 64 characters. The worst case scenario is that the user will have to memorize a random sequence of 5 or 8 characters just as with an alphanumeric scheme; however, based on research of locimetric schemes like PassPoints, the picture superiority effect and cued recall will assist the user recall a longer password than alphanumeric schemes with less error.

To avoid the possible problems involved in users writing down the text of their password or communicating their password to others, a multiple of each character is placed on the graphical password image. First, a random generator picks a subset of upper or lowercase characters and single digit numbers to form a list of 45 characters. From this list, each character is replicated to give 4 copies of each character which are randomly placed over the image when the user first sets up their password. Even if the user writes down their password text, there are 4 copies of each character; and hence, the password is still not uniquely defined. If the user's password were known to an attacker simply by the text, given a password of 8 characters long, there would still be a password space of 4⁸ or 65,536 possible choices. If screen capturing is disabled, the user would have to manually sketch the password text and their locations. Though this will not prevent a user from communicating their password, it does make it more difficult when compared to alphanumeric passwords.

The present invention also avoids the problems associated with hot-spots in the graphical password image. As explained above, hot-spots may be found in graphical password images due to the prominence of artifacts in the image. For example, in FIG. 3, the text around the astronaut is easy to find and remember compared to the black space above the moon. An attacker might suspect that the astronaut is a region of interest when guessing the user's password. These hot-spots can be eliminated if the user is persuaded to use more random locations. To accomplish this persuasion, the user application will darken and disable random click-spots while the user is setting up their password. Some random points may be near hot-spot areas but not all of them. Heuristic image analysis could be automated to further restrict how many random points are allowed in image areas with certain features. Additionally, adjacent text on top of the image could form a hot-spot. For example, adjacent letters might form the word “cat”. It would be useful, therefore, to have a persuasive method that can look for dictionary words with adjacent text. For the present invention, half of the points on the image will be allowed as a password choice. Those that are allowed are randomly chosen and do not account for image features or adjacent text.

It should be noted that the password space resulting from the choice of 8 out of 180 items, randomly placed on an image, is larger than an 8-character alphanumeric password. However, there is more information that can be encoded with each click-point that creates an even higher source of entropy. Unlike alphanumeric passwords, which only have 64 usable characters as a source of entropy, an image has a large source of features that can be captured by decomposition techniques. The image, under the text where the user clicks, will contain pixels of various colors. Additionally, the whole graphical password image, with the random text, their random positions, and the image can be unique among a large population of users, especially if users provide their own personal image. Using these collective factors of variability in a graphical password, it will be possible to stretch a 5 to 8 point selection to a 32-byte output: the amount required for a 256-bit AES encryption key are a very long, random alphanumeric password.

For better security for the password or access provision means, a cryptographic hashing method is used. It is the goal to transform the entropy of the graphical password and chosen click-points to a 256-bit, AES key or 32-character text password. Using 256 bits gives password space 1.16×10⁷⁷ possible combinations. To accomplish a collision-free password, a cryptographic hashing system offers a realistic implementation mechanism. However, this assumes that the combination of what the user selects as a password, and the graphical password image, can give an input value with no collisions. A cryptographic hashing function still requires that the input be unique across all users of the graphical password system to be more secure against password guessing.

To provide a unique input message to the cryptographic hash function, the uniqueness of the user's family photo will be used to derive a unique image hash. The input to the cryptographic hash function follows: H*(H(image)+CP)=P_{key}²⁵⁶ where CP is a stream of click-point data from the graphical password, H is the image hash function and H* is the cryptographic hash function. The image hash function will offer the largest contribution to uniqueness of the input message since the click-points only constitute 1.1×10¹⁸ possible combinations if 8 click-points are selected. An image is composed of pixels which are defined by a red, green, and blue color channel having values from 0 to 255. If each value in the color channel was an independent event with equal weight, the theoretical combinations would be (256)³*^{p} where p is the total number of pixels in the image. Given an image composed of 451×331 pixels, that is 256⁴⁹⁷⁸⁹³. With such a large number of theoretical combinations, it is safe to assume that if every user picked their own family photo, the possible permutations approach an infinitely large set. However, with this system, the image is too large to form a message into the cryptographic hash function; therefore, a reduction to a smaller, unique hash value is necessary.

The image hash function will use a histogram composed of counts that represent how many color value averages in a P×P pixel block that are above a certain color threshold of any red, green, or blue color channel. This is a simple yet effective low-pass filter. Added to each histogram value is a corresponding permutation. The graphical password image will be of the dimension W×H pixels and will be partitioned into non-overlapping P×P pixel blocks for a total of W*H/P² blocks. The total histogram values will be the integer value of W/P indicated by L. In this solution, L=56 histogram values of one byte each. Each color channel will be represented by R=red, G=green, and B=blue. The image threshold for each color channel will be:

$$\overline{{T}_{R}} = \frac{1}{{N}_{p}} {\sum }_{i}^{W} {\sum }_{j}^{H} {R}_{ij} , \overline{{T}_{G}} = \frac{1}{{N}_{p}} {\sum }_{i}^{W} {\sum }_{j}^{H} {G}_{ij} , \overline{{T}_{B}} = \frac{1}{{N}_{p}} {\sum }_{i}^{W} {\sum }_{j}^{H} {B}_{ij} .$$

The threshold is defined for red, green, and blue respectively, where Nₚ is the total number of pixels in the image. Each block will have an average RGB component:

$${\overline{B}}_{lm} = \frac{1}{P \times P} {\sum }_{i}^{P} {\sum }_{j}^{P} {C}_{ij} .$$

The value Cᵢⱼ is composed of values R, G, and B for each pixel at the i^{th} and j^{th} position with respect to block Bₗₘ and l is the index for the block along the length of the image and m is the block offset along the height of the image. Each histogram value is computed by:

$${N}_{l} = ( {\sum }_{m}^{n} {\overline{B}}_{lm} \geq \overline{{T}_{R}} ) ⋁ ( {\sum }_{m}^{n} {\overline{B}}_{lm} \geq \overline{{T}_{G}} ) ⋁ ( {\sum }_{m}^{n} {\overline{B}}_{lm} \geq \overline{{T}_{B}} ) .$$

The value Nₗ is the count at position l of L. If any value is larger than 255, the upper limit of a byte, the value will be allowed to roll over. However, the mean color for each channel, as the threshold, keeps the count to a relatively low number compared to 255. A permutation is added to the final count before moving to the next index in the histogram. The permutation is computed using only the blocks with a color channel that have an average equal or greater than the threshold for blocks l to m given as: Kₗ=K₁ [symbol] (B_{lmR}+B_{lmG}+B_{lmB}) [symbol] Bₗₘ≧ T̅. If the permutation that is added to the count is over 255, the value in position l of the histogram will be allowed to rollover. Finally, the histogram image hash is represented as:

$$H ( image ) = {\sum }_{l}^{L} {N}_{l} + {K}_{l} .$$

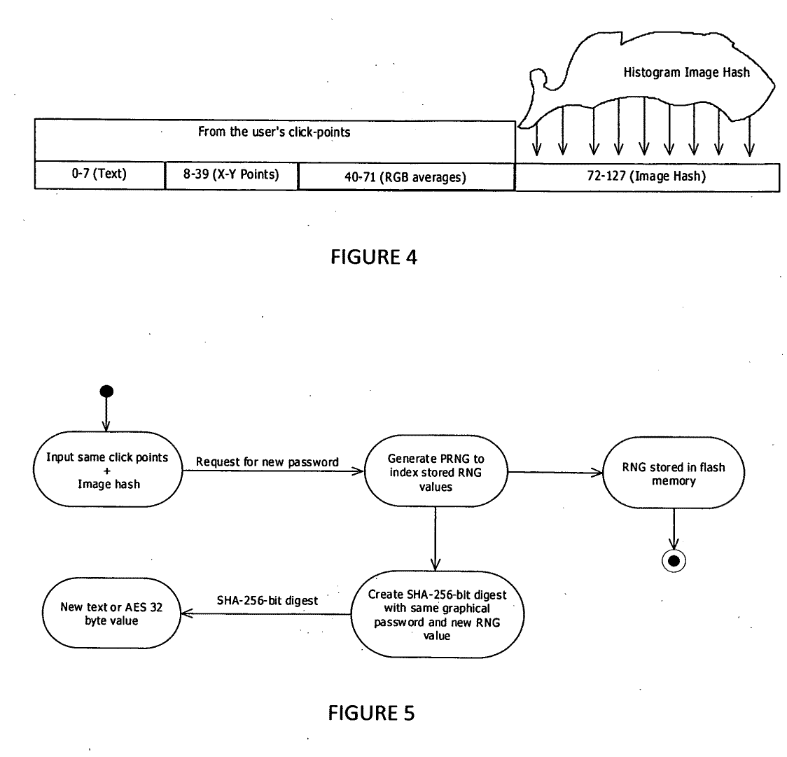

When the user clicks on the graphical password, in the designated areas, both the text and its location are unique to that graphical password. In addition, the pixels under the text may also be unique, though not necessarily. For each point the user clicks, a sweep of a 10-pixel radius over the image underneath can be used to find the average color. If the user chooses an 8 click-point password, that would result in 8 bytes of ASCII text, 32 bytes of x-y data (each x-y value pair contains two words of data) resulting in 40 bytes of data. The average color of the image with a 10-pixel radius about each point adds 8 double words of data or another 32 bytes. Therefore, from an 8-click password there will be 72 bytes of data. If that is added to the image hash calculated above, the result is now 128 bytes of data as the message for the cryptographic hash function. Though it may be possible to have a collision, it seems unlikely with 128 bytes of data elements derived from the uniqueness of both the image and the user's click-points (FIG. 4).

Using a cryptographic hash function will provide some security on the contents of the data collected from the user's graphical password and will also provide a 256-bit result. Two attributes of a cryptographic hash function that are useful:
It is extremely difficult to reconstruct the input data from the output.
It is extremely unlikely that the hash function will produce the same output given different inputs.

One such cryptographic hashing function which may be used with the present invention is the Secure Hash Algorithm (SHA) 256 (compliant with the FIPS Publication 180-2 specification). The SHA-256 hash function will give a 256-bit digest that can be used as a 256-bit AES key or used as alphanumeric password. However, for security, it is important that the user create their password using the correct device. Therefore, random (RNG) values stored in the device will be added to the input of the cryptographic hashing along with the graphical password components mentioned above before it returns to the user as a final password (see FIG. 5). Since a cryptographic hashing function can produce an output that is difficult to relate to the input with just a one bit change in the input message, one or two RNG values will be all that is needed from the device's storage.

The text-based password scheme currently in use on the Web today would be impractical to replace anytime soon. The weakness of the text-based password scheme is not only because of key-logging and clipboard directed spyware, but the fact that users tend to use easy-to-guess passwords. Graphical passwords have typically been used to work with special infrastructure, such as Passface™. Using the message digest from the cryptographic hash function in the device, 32 bytes containing values from 0 to 255 can be mapped to text characters. Although ASCII ranges from 0 to 127 and extended ASCII up to 255, authentication applications may allow only 26 upper and lowercase text, single digits and the common special characters found on most keyboards. In some instances, the single quote, double quote, and back-tick are not allowed because they are used in some SQL and script injection attacks. If the values in the 32 byte (256-bit) message digest are random and unique across a large population of users, then the values in each of the bytes can be considered a good source for choosing text from a set of allowed characters. Using each byte in the message digest, a mapping function can be derived such that P_{key}²⁵⁶(i)={allowed ASCII set} where P is the cryptographic digest function and the value at index, i, is mapped to allowed ASCII text. It might be possible to use most of the ASCII and extended ASCII set; however, if leaving off a few possible blacklisted characters and using only 90 items, that would leave 90³² or 3.4×10⁶² theoretical combinations for a 32-length alphanumeric password. Putting that in perspective, if all of the values, ranging from 0 to 255, could be used then the password space would have 1.16×10⁷⁷ combinations. Using less than half of the range reduces the password space significantly but still is dramatically higher than an 8-character alphanumeric password and it is derived from statistically independent, random values that are highly resistant to dictionary attacks.

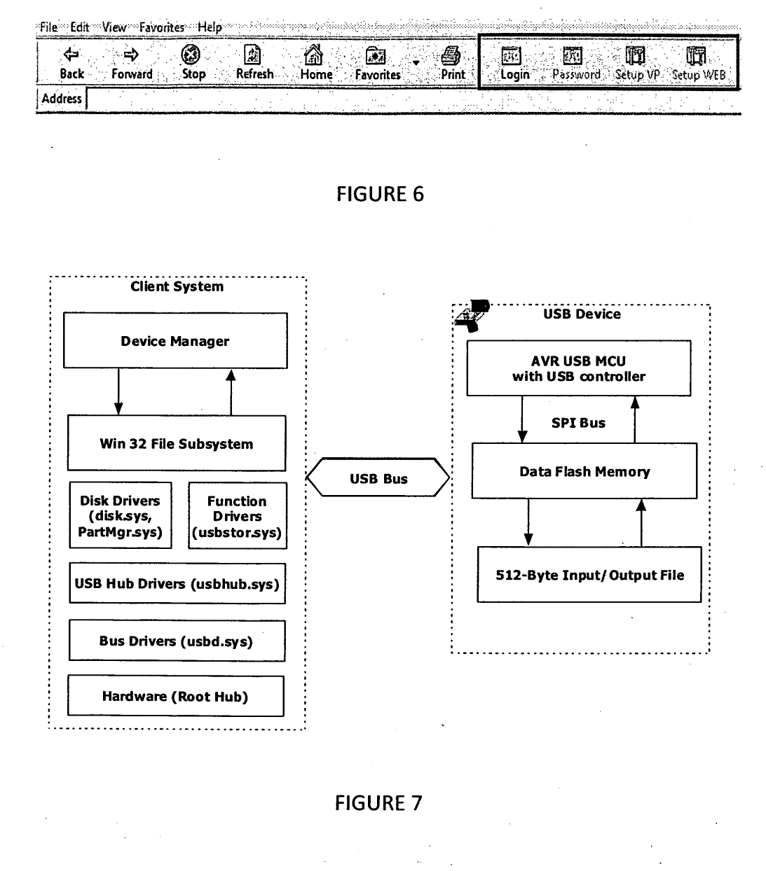

It must be noted that it is not enough to provide only a graphical password to the user. A graphical password must work with the current infrastructure in a secure manner and provide a more secure solution than current text-based password schemes. Therefore, the present invention provides a secure Web browser with the following attributes (a screen shot of the browser toolbar with the graphical password buttons is shown in FIG. 6):
The graphical password is integrated into the Web browser.
The application helps the user setup a device login graphical password.
The application provides a login screen to the device.
A graphical password is provided that can be used to generate a text password used for authentications.
A text password is automatically inserted into the password field without the keyboard, clipboard or other easily attacked methods.
Stores links in the device as favorite links so the user will not have to type URLs.
Inform the user if any Trojan attacks occurred and abort the application.

To set up the graphical password, a user would use the toolbar illustrated in FIG. 6. The browser's toolbar has a menu for the graphical passwords and setup utilities. The user should not have to exert any special effort to input a password. Clicking on the toolbar to active the graphical password is all that is needed. The user will initially get a device with a default password. Since a graphical password is hard to communicate, unlike a PIN, the user will be given a pseudo-PIN issued with the device. The pseudo-PIN will be any five letters or numbers on a pre-loaded graphical password without regard to position or case sensitivity. After the user enters their pseudo-PIN on the pre-set graphical password, the user will need to find two images that they like. One image will be used for the login to the USB device and the other for their Web passwords. The image, as mentioned before, can help aid in cued recall. However, it also serves as a security feature. Since the user will pick an image they prefer, the user will know if this is their device. If someone switched their device, the user would know it before entering their password. Once the image is setup, the user can press a button to randomly generate the text and associated circles over the image. When ready, the user will select a password with the appropriate minimum requirement. In contrast, the graphical password for Web-based passwords is never setup (except the image and overlaying text). No Web passwords are stored in the device for security reasons; therefore, the user must always enter their Web password every time as needed.

After logging into the device successfully from inside the Web browser container, the user can select or type the URL to a login Web page. The user will activate the Web graphical password from within the browser and click the password. Once the Web browser receives the device-generated text password, an obvious indication will notify the user that the password is now ready for insertion into the password field. The user will then just click the mouse pointer on the password field and the underlying application will find the HTML document object and programmatically insert the password into the password field without the use of the clipboard. Any buffers holding the password are inside the client process and are not accessible to Trojans.

One problem with text-based passwords is the cognitive load on users to maintain many different passwords and constantly remember new ones. For better security, many administrators will require a password to expire. With many passwords to remember on a regular basis, users tend to write them down and put them in insecure locations. With the solution proposed, using the security of the USB device and the cryptographic hashing function, a user will be able to generate many long, random and dissimilar passwords from the same graphical password image and the exact same sequence of click-points. In addition, for security, there is no need to store the user's password in the USB device to accomplish this.

As previously mentioned, both the click-point information of the graphical password and the results of the image hash are used as one part of the input to a SHA-256 cryptographic hash function. Additionally, random values in flash memory are added as the device's contribution into the hashing function which results in a 32-byte (256-bit) digest. True random (RNG) values that are added in the device and are an important part because it enforces the use of a particular device to generate the correct 32-byte digest. Additionally, changing the random numbers can result in a completely different password with the same graphical password input. Along with the RNG values, more information could be added to the hashing function to create a different password with the same graphical password input. Specifically, input to the hashing function could also include the root URL of the Web site login page (FIG. 5).

In order to allow the user to keep the same click-points on the same image to generate a completely different text password, or AES key, the RNG values can be a variable input. If the user wanted to change their alphanumeric password, the user would need to notify the client system which subsequently would tell the device to change the RNG values it currently uses as the input to the cryptographic hash function. The last RNG value for the password would be stored in a special place in flash memory and used each time the password is required. This way, the user would not need to learn a new set of click-points for a new text password or AES key. Since an important property of the cryptographic hash function is to change the output dramatically with as little as a one-bit change, any new RNG values will generate a completely new 32-byte message digest for either an AES key or text password. This would also be the mechanism used by the client system to send encrypted messages to the server using many different AES keys. The device will keep changing the RNG value for each request and a new AES key is the result. If an AES key and a text password are generated independently, RNG values must be stored separately as well. It is important to note here that the RNG values used are created at the factory by a true random generator because the device is only capable of pseudo random (PRNG) numbers. A PRNG value, however, can be used to index into a series of factory installed random numbers and to increment from a base RNG number. That is, an RNG value added to a PRNG value can result in a larger set of numbers than what can be preinstalled.

Changing the password is necessary for better security but this does not take into consideration the need for multiple passwords for multiple logins. One password used for all Web sites is a potential weakness should it become compromised. A better solution would be to have a different password for every Web site. The client system could help the user keep a different password for each Web login using the root URL as another input to the cryptographic hashing function. Once the user chooses a Web site to login, the password click-points and root URL are sent to the device. By definition, a URL is unique and would result in a different message digest. Again, the device does not store the user's click-points but would store the root URL and RNG values. Now, the URL is added to the input with RNG values as before. A different 32-byte hash value will result for each URL and hence, a different text password can be generated without the user changing the graphical password input. The device can also store the URL so the user will not have to type it the next time. Storing the URL might preclude mistyping the URL and landing on a phishing site. The application could also have a heuristic mechanism to scan suspicious URLs and warn the user.

To communicate with the hardware device, the Device Manager on the user application relies on the operating system's underlying support of SCSI devices. The two endpoints for all communications are the Device Manager in the client application and Crypto Device embedded in the microcontroller of the USB device.

Commands/responses are sent/read in 512 bytes of encrypted data to an input/output file defined in the File Allocation Table (FAT) of the device's flash memory (FIGS. 7, 8, 9). That is, for the endpoints to communicate, one file is registered in the FAT table as 512 bytes in length. There is, however, no real file. Additionally, the FAT table is formatted for 512 byte sectors of data storage. Therefore, data sent to and from the device fit into one FAT sector. In this implementation, the operating system must support the FAT designed by Microsoft.

Regarding reads and writes to the device storage, the microprocessor intercepts all SCSI commands. If the user application saves data to a file on the USB device, the SCSI command will be intercepted along with the sectors of file data. Then, the microprocessor will decide from the sector address what to do with the data. If the data is in a sector that is allowed, the microprocessor will decrypt and read the data sent. If the sector is not valid or allowed, the microprocessor will throw the data into a bit bucket (an area to throw illegal sectors of data). The microprocessor will always report success for SCSI commands that contain illegal sector addresses but the microprocessor will silently throw them away. Likewise, if the user application reads a file, the SCSI command to retrieve a sector of data on the flash drive will be intercepted. If the sector is not an allowed sector, a warning text message can be sent in what would have been the file's data.

Read-only access to the FAT table must be allowed so the input/output file and the executable can be accessed. All other sectors in the flash are protected by the microcontroller. If the input/output file is manually opened, the microcontroller will detect an invalid access, as discussed in following the sections, and return an “access denied” statement to the user.

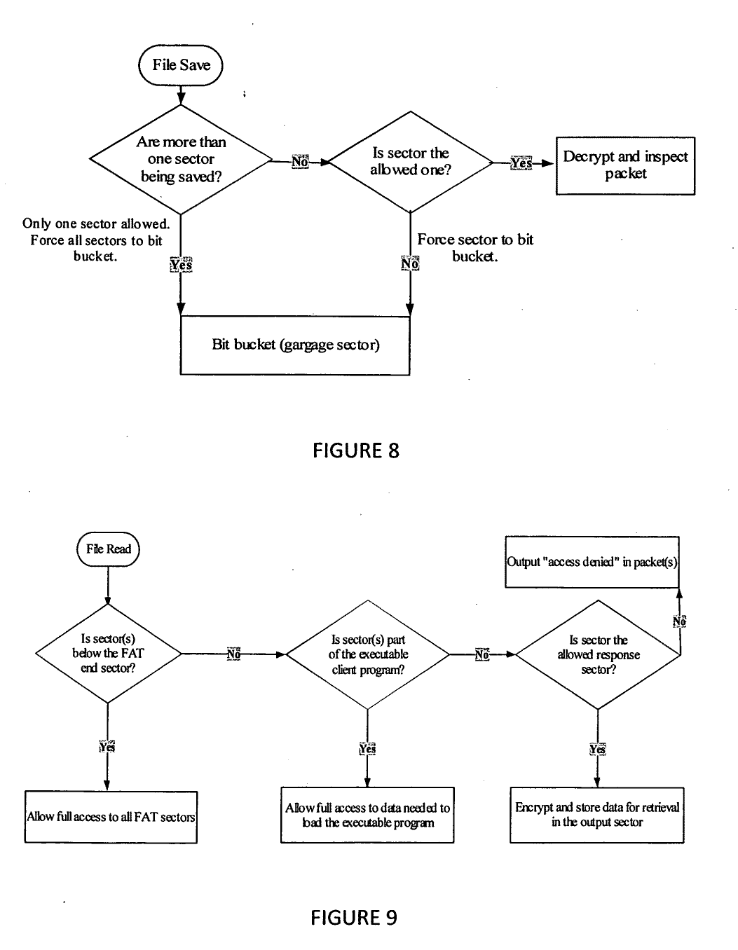

The flowcharts of FIGS. 8 and 9 illustrate the above scheme. FIG. 8 presents an overview of the action the device takes when the user application saves data. FIG. 9 presents an overview of the action the device takes when the user application reads data.

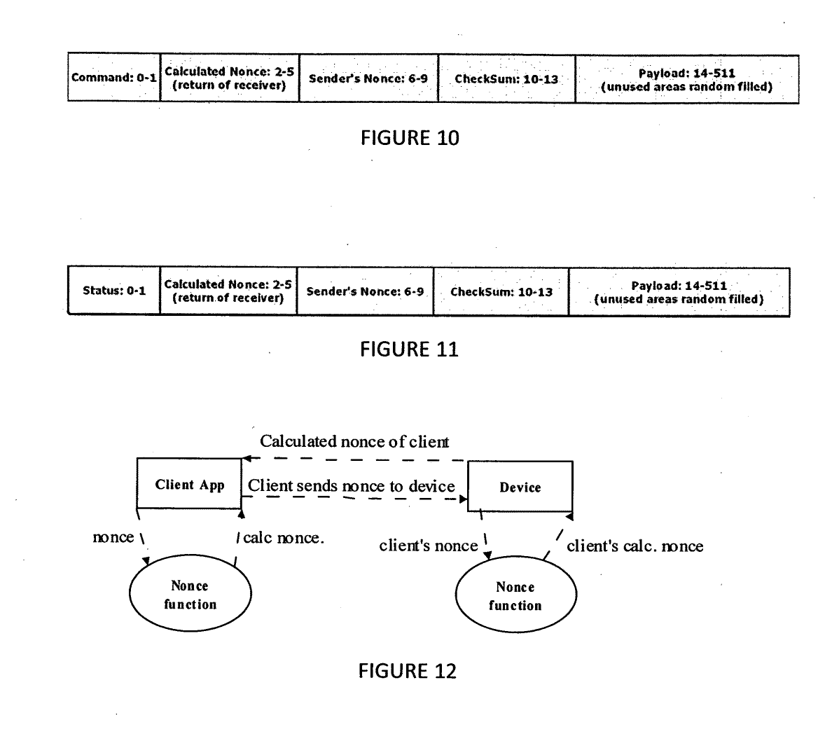

As was mentioned, the FAT sector is formatted to 512-byte sectors of file storage. For this reason, a 512-byte file is used for input/output. Though a file bigger than 512 bytes could have been used as the input/output, most of the data exchanged fits into 512 bytes. The exceptions are the image data and the x-y coordinates for the graphical passwords. For those data items, multiple exchanges to the same input/output file are used. The Device Manager module of the client system sends commands to the microcontroller with the data structure in FIG. 10. Responses are read from the device in a data structure defined in FIG. 11.

For both data formats in FIGS. 10 and 11, the first field indicates what action to take on the data. The next three fields are used for security and data integrity as discussed. The last field is the payload and contains up to 498 bytes of data. Because data is streamed in a series of bytes, the byte order for the data types must also be defined. Most of the data is streamed in “Big Endian” format. However, “Little Endian” is used for the x-y coordinates of the graphical password text. A summary of all the commands and accompanying data in the payload is outlined below.

Given that sensitive data is being communicated between the user application and the USB device, robust security features must be employed. Data is flowing through the operating system's file I/O system and a Trojan could inject itself as part of a system I/O module and intercept any and all file data. Hence, Data from the client process to the embedded device must be strongly encrypted. In particular, the data should be transmitted using a strong encryption method, resistant to replay attacks, and resistant to implementation attacks.

One encryption method which may be used complies with FIPS PUB 197, AES Data Encryption Standard. Data is encrypted with 256-bit AES cipher-block chaining (CBC). AES is a block cipher and the danger is that if the data is the same in each block, the output will be the same. For this reason, CBC is used so that each successive block of plain-text is XORed with the previous cipher-block. However, that will not preclude a replay attack. A replay attack is where the attacker does not need to know the contents of the encrypted data to cause harm. For example, if the client application sends encrypted data to the device each time the user logs in, the attacker could capture this stream of data and apply the same stream of data to the device to get the same response as the legitimate packet of encrypted data. The attacker could then log into the device merely by stealing the encrypted packet of data. For this reason, three fields, of four bytes each, have been added to the command and response data packets (see FIGS. 10 and 11):
Calculated nonce
Sender's nonce
Payload checksum

To prevent replay attacks, the encrypted data can be made to have varying cipher text output for the same plain-text. To do this, random values need to be placed in or around the plain-text data. For this, nonces will are used. A nonce is a random number once used. Each endpoint will create a nonce value for each plain-text payload before it is encrypted by AES. No two cipher-data transmissions between the endpoints should ever be the same. The problem is that the hardware for the USB device can only generate pseudorandom numbers (PRNG) as opposed to truly random numbers (RNG). The problem is finding a “seed” that does not fall into a finite set of values that could be guessed. Due to constraints in hardware cost, the seed value for the USB device should be stored in flash at the factory using a true RNG. The pseudocode for the PRNG of the client and device is as follows:

User application :
srand(time(0)\hat{ }CPU_ID\hat{ }timerticks)
prngVal=0
while(!prngVal)

prngVal = rand( ) % ((int)pow((float)2,(int)30))

USB or USB Device :
RNGarray[256] = { 256 RNG values from factory }
RNGarray [timerticks%255] \hat{ }= timerticks
prngVal = timerticks\hat{ } RNGarray [timerticks%255]

Where timerticks are the milliseconds since the device was plugged into the USB port, and RNG is a true random integer value set in flash memory at the factory. The client application can use an API that generates a PRNG but also seed this value using some hardware ID such as the CPU serial number and the time in milliseconds since the application was started.

A second layer of randomness is added to each transmission of data. With the exception of the image data that fills the whole payload, there is always some room in the payload after all the necessary items are added. In the remainder of the payload, random values from 0 to 255 are added after the valid data. With a nonce followed by random values in the remaining parts of the payload, a replay attack is extremely difficult undertake. However, the attacker could use brute force to find a break in the system. By using an automated tool and writing various streams of data to the device, it might still be possible to find an implementation weakness. Hence, there are two more fields in the data packet to further reduce implementation attacks based on brute force. One is the calculated nonce value and the other is a checksum value.

The payload integrity is verified with a sensitive checksum that can find a difference even if one byte value is increase and another decreased by the same amount. A checksum should include all valid data and randomized data in the payload in order to catch any changes anywhere in the payload. If a brute force attack occurred, it would be very unlikely that the payload would checksum correctly once it was decrypted. The pseudocode for the checksum is as follows:

len = byte length divided by 2
while len is not 0

begin
If len < 16,384 then

l = len

else

l = 16,384

len = len − l;
for 0 to 1

begin

sum = sum + data_value at index
index = index +1

end

sum = (sum and HFFFF)+ (sum shift right 16)

end

sum = (sum and HFFFF)+ (sum shift right 16)

A nonce may also be used to increase the security of the present invention. The idea of a calculated nonce is based on a shared secret that is added to part of a public value to return a hard to guess value that will validate a conversation between two parties. If both system A and system B share the same function and some secret, system B sends a numeric value, x, to system A; and system A inputs the value into the shared function along with its secret and gets value y. System B also inputs value x into its function with its secret and gets value y. When system A responds to system B, the value y is sent with a message. System B then compares the calculated value from system A with its calculated value. If those values match, then it is very probable that the message from system A is authentic, provided it is hard to guess value y given x. The idea can be applied to a nonce value and secret as an input to a shared function to get a hard to guess output value. The concept of the nonce is diagrammatically illustrated in FIG. 12.

When the client's nonce is received by the device, the device sends the nonce into its shared function and returns the calculated nonce with the response data packet. The client application will then verify that the calculated nonce matches what it expects. Likewise, the USB device will send its nonce and store a calculated nonce value it expects to receive in the next command packet from the client. The result is that data packets always depend on a state of the last calculated nonce they expect. These values change in every transmission, are random, and enforce a specific order of commands and responses. If the calculated nonce values do not match because the packet order is not synchronized, the packet is too old, or the packet simply does not have the expected calculated nonce, the packet is rejected.

The idea of a calculated nonce depends on a shared function that will give a hard to guess output. The key, then, is the function. For this calculation, the same checksum function that checks the payload integrity is used. The checksum function must be highly sensitive to any changes in the data. The executable running on the client's PC (the user application) is composed of machine code that can be used to obtain a checksum. Using the random nonce value discussed above, the nonce can be used as an index into the executable file. Because the nonce value may be bigger than the executable size, a modulus of the nonce value and the file size can return a start index into the executable from which to begin a checksum. The checksum derived from a random offset into the executable to an endpoint, or end of file, will also produce a random output but not one that is difficult to guess. That is, since all of the clients run the same executable code, all that would be needed to guess the calculated nonce is the input nonce, the executable, and the checksum function.

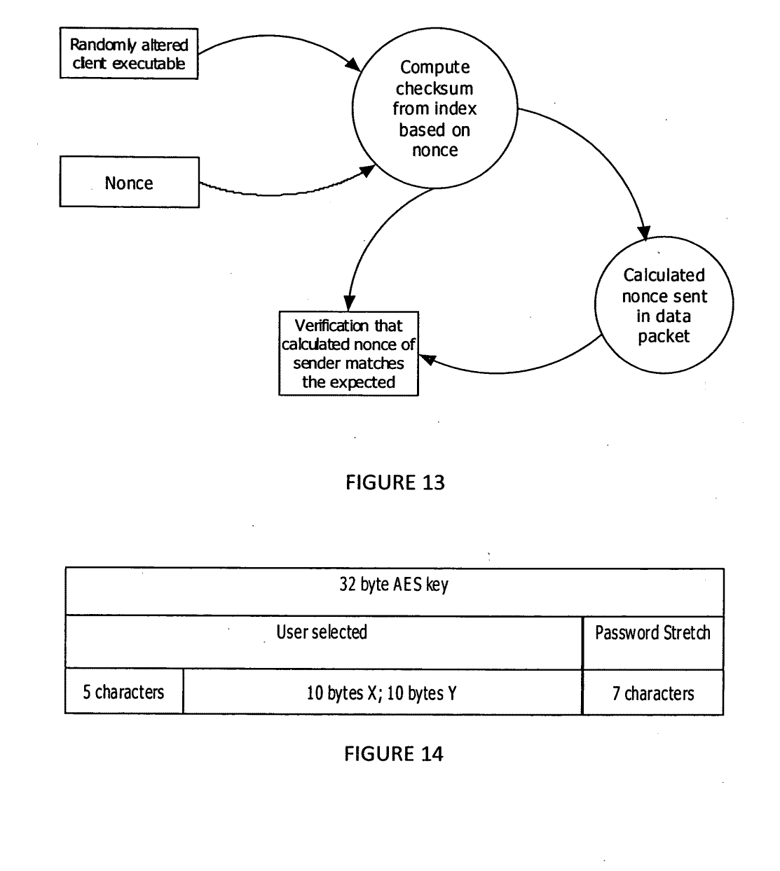

The idea, then, is to not have the same executable code that produces the same checksum. In short, the machine code in the client's executable can be altered at random locations to produce completely different calculated nonce values than other clients (see FIG. 13 for a diagram of the above). This will, however, require that the microcontroller in the USB device run the same checksum on the executable file stored on the flash drive as the client will have to do on the running executable. For many cheaper microcontrollers, that may require too much processing speed. Therefore, it may suffice to run the checksum over one or two sectors of the stored executable so processing time is less. If the modifications to the executable machine code are in frequent locations, it would not require a full checksum of the entire client executable's machine code. For example, if the random nonce value generated by the device points to a random point in the executable file, the device could checksum from that point a few sectors of the file to get the calculated nonce it expects from the client. The client will also use the device's nonce value as a starting point to perform a checksum for the same length as on the device. That calculated nonce value of the client must match the one the device calculated. If the client executable had enough random modifications in most areas of the file, then the calculated nonce will have a low probability of being the same on any two client executables.

Using both the calculated nonce and the payload checksum, the integrity of the payload and the authenticity of the packet can be verified. Any implementation attack would have to make sure that both the calculated nonce and the checksum are exact. If those values are not correct, the packet is rejected by the client or the device. Additionally, the device will monitor how many times it receives a bad packet of data. Therefore, any implementation attack could not use successive attacks.

Another defense against implementation attacks is that SCSI file I/O is a well known protocol and uses common operating system libraries. The problem with using a proprietary system is that it might have weaknesses in its implementation that have not been vetted over an extended period of time in the field. By using a well tested protocol and libraries, accidental implementation faults are likely to be minimized. The other benefit is the exposure to antivirus and anti-spyware applications. Since an operating system library is responsible for transferring data on the PC, a Trojan or a virus could attack it. Anti-virus and anti-spyware rely on databases that contain signatures of malware and also the correct checksums of operating system libraries. A proprietary library's checksum is unlikely to exist in a database of signatures and an anti-virus or anti-spyware program may miss the infection based on a checksum of the library code.

As discussed above, data packets are verified with a calculated nonce and payload checksum, however the core of the authentication revolves around the AES encryption and how the 256-bit keys are created. It should be emphasized that there is no standard login with a username and password scheme. Rather, “login” means that the device successfully decrypted the data packet and finds the expected command, payload checksum, and calculated nonce to be correct. A “login failure” is where the device decrypts the data with the expected AES key but invalid data is the result. If the device detects an invalid data packet, this is regarded as a login failure. In short, the device is constantly checking for incorrect packets and will increment the failed login count during any part of the session if it finds one.

There are two AES keys and two encryption levels when' transferring data. One key is considered weak and the resultant encryption is considered unsafe but might be helpful to keep casual attackers away from the data. The other key is the strong key stored in the device and is the crucial key for encrypting/decrypting sensitive data packets. It should be noted here that the AES key stored in the device is the only piece of sensitive data and has nothing to do with the user's password for Web authentication. The AES key stored in the device is only used to encrypt data between the user application and the device. If the device is stolen, the attacker still does not have the password for authentication.

Weak encryption is used when the user application needs the first graphical password to authenticate with the device. That is, only the graphical password image, text, and x-y locations for the text are sent to the client application under weak encryption. In essence, if the USB device were physically stolen, the attacker would see the first graphical password screen anyway. The data during weak encryption is encrypted from a 256-bit key that is sent from inside the Portable Executable (PE) of the client application. In the PE file format, detailed by Microsoft, the first section of the file is called the DOS header and the structure is defined later in this document.

Since Microsoft states this is a legacy section not used in Windows, the reserved words at byte offset 40 of every Windows PE can be used to store a 20-byte random value. When the microprocessor of the USB device gets the request for the first sector of the client executable file data, it can find the offset to position 40 and stuff a random, temporary AES key into the DOS header. When the client executable loads, it can check its own header, which is an offset of 40 bytes from the base address of the process, to extract the AES key to decrypt the first graphical password being sent by the device. An attacker could still capture the transferred bytes of the executable and extract the AES key. Therefore, such a scheme offers a mild form of protection against simple attacks. There is, however, a stronger security feature from this scheme.

Stuffing an AES key into the DOS header of the client executable, on the fly, creates a unique executable. No other client executable would have the same value in its header information. This AES key could also be composed, in part, from milliseconds when the device was plugged in to the USB port. The desired result is twofold:
The client executable will only work with the particular device it was run from.
The client executable will only work for a certain period of time before requiring a restart.

For example, if the user copied the client executable to another storage medium, from the USB device, the executable would have the temporary AES key in its header. If the user ran that executable, it would work until the key expired. Restarting the client executable outside the device would mean the device and the executable would have AES keys that are now different and hence the device can no longer communicate with the client. This will help prevent a user from using a virally infected client executable. That is, the user can never run the executable outside the device where it might be easier to be infected. Likewise, if the user received a malicious executable, such as a Trojan, and ran that application outside the device, the USB device and the executable would not be able to communicate.

With the first AES key being used in the initial communications between the user application and the device, the second AES key is the one that encrypts the most sensitive information. For example, encryption with this second AES key is used when the user builds their password for Web authentication. For this reason, encryption with this key is the most important to prevent attacks. Additionally, this key must be stored in the device. The user clicks on the first graphical password to build this key within the user application. If it is enforced that the user will chose a minimum of 5 text items on the graphical password, then there would be 5 text items and 5 positional values captured. That would mean 15 distinct items are unique to a password:
5 letters or numbers (one byte each)
5 x-positional values (two bytes each)
5 y-positional values (two bytes each)

The AES key used for encryption and decryption is 256 bits, 32 bytes, long. If a minimum of 15 unique values are captured, 10 of which are 2 bytes long (short), then that provides 25 bytes to fill the AES key. The remaining 7 bytes can be derived by password stretching using 15 unique values the user selected and the text used for the graphical password presentation. There are 180 text values presented to the user involving 10 digits and 26 upper and lowercase ASCII characters. An array of 180 bytes with random text stored in each byte is used to build the graphical password presentation. Therefore, an index from 0 to 179 can be used to reference the random text values. The index to this array can be derived by using what the user selected and subtract a base value and add an offset to get the index (see Table 1 below).

TABLE 1
Password stretching

| | | | | Index into |
|---|---|---|---|---|
| ASCII Text | Values | Subtract | Add | 180 byte array |
| 0-9 | 48-57 | 48 | 0 | 0-9 |
| A-Z | 65-90 | 65 | 10 | 10-36 |
| a-z | 97-122 | 97 | 36 | 37-63 |

As can be seen, password stretching can occur by using the text the user selected and the mapping into the array of random text. This will result in adding 5 more text items to the previous 25 leaving 2 more to go. Using the x-y values, a similar mapping can occur. If the image resolution is 331×451 pixels, then use the remainder from the x and y positions divided by 180 to get a zero-based index. Additionally, adding an offset as described with the text will grab the other values in the 180-byte array. FIG. 14 illustrates the construction of a 256-byte AES key.

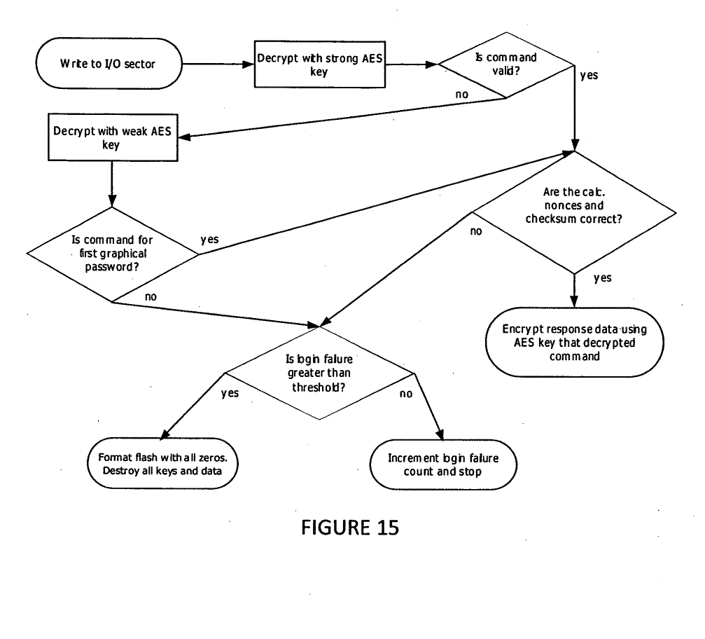

A required sequence must take place when transferring data. As mentioned earlier, there is no distinct login command. Rather, the AES key is switched from a less secure encryption level to a higher encryption level. Once communications are switched to a higher encryption level, the level stays in effect until the client application is terminated. FIG. 15 is a flowchart showing what the device will do when it receives 512 bytes of data in the allowed command file. Later in this document, a table will show what commands are sent with what AES key.

The USB device is read-only, and hence, it is not possible for malware to infect the storage medium. This physical security, however, does not protect the executable when it is loaded to the user's PC from the device—after all, the executable is just a file. It might be possible for malware to attack the file during or after loading the executable. For example, a Trojan could masquerade as a valid file I/O module such as disk.sys. Likewise a virus could be injected into the PE as it passes through the windows subsystem. Therefore, there are two approaches for malware countermeasures:
Have the client executable to check itself for infection.
Have the device verify the client executable before it accepts any data from it.

A client checking itself for a virus is a weak from of protection if the virus has modified the executable significantly or even replaced it. Therefore, this check is only useful to warn the user. A more secure countermeasure is for the device to know if client is infected and abort or possibly self-destruct.

It is possible for the client executable to check itself to see if the PE data has been altered. The checksum algorithm must be very sensitive to any change that might increment one value in the executable and equally decrement another. The client would need to compare the self-checksum with a value assumed to be correct. To find the correct checksum, the client application can query the device. Recall that the header of the PE was changed when a random 20-byte AES weak key was added. This addition changes the checksum of the total executable. In essence, because of this numeric value, no instance of the same executable would have the same checksum. This implies the device also needs to run the same checksum on the full executable as it leaves the device. Microsoft provides an API that checksums, when given the base address of the loaded image. However, since Windows API's do not work on the device, the checksum function used for the payload integrity check will also be used by both the client and device starting from the image base address. This scheme assumes a viral infection will not disable the client from checking itself.

A Trojan could completely replace the executable image as it passes through the subsystem with a Trojan executable client application. To prevent this scenario, recall that calculated nonces are used to perform a packet security check based on every client executable having a unique checksum. If a virus modifies or replaces the machine code, the checksum will change and so too will the expected calculated nonce values. In order to create executables that will work exactly the same on every PC but have a unique checksum at random locations in the executable, a No Operation Instruction (NOP) machine code can be inserted into the client application source code at random locations before compilation. The NOP specifically does not change the state of any registers or data but does increase execution by 0.4-0.5 clock cycles on newer Intel processors. Additionally, function offsets are changed which might help obfuscate the code to an attacker. Inserting random NOPs into the source code can be done at the factory where true RNG values can be generated.

When the device sends a nonce value to the client, a matching calculated nonce value is expected by the device. If a virus has inserted itself into the executable, the checksum will change for the total executable. If NOP values are inserted in various parts of the machine code, the checksum at random locations of any part of the executable will be different for every client. This will make it difficult for any virus to know how to insert itself without changing the expected checksum. If the device detects an unexpected calculated nonce as a result of a viral infection, the device can destroy itself.

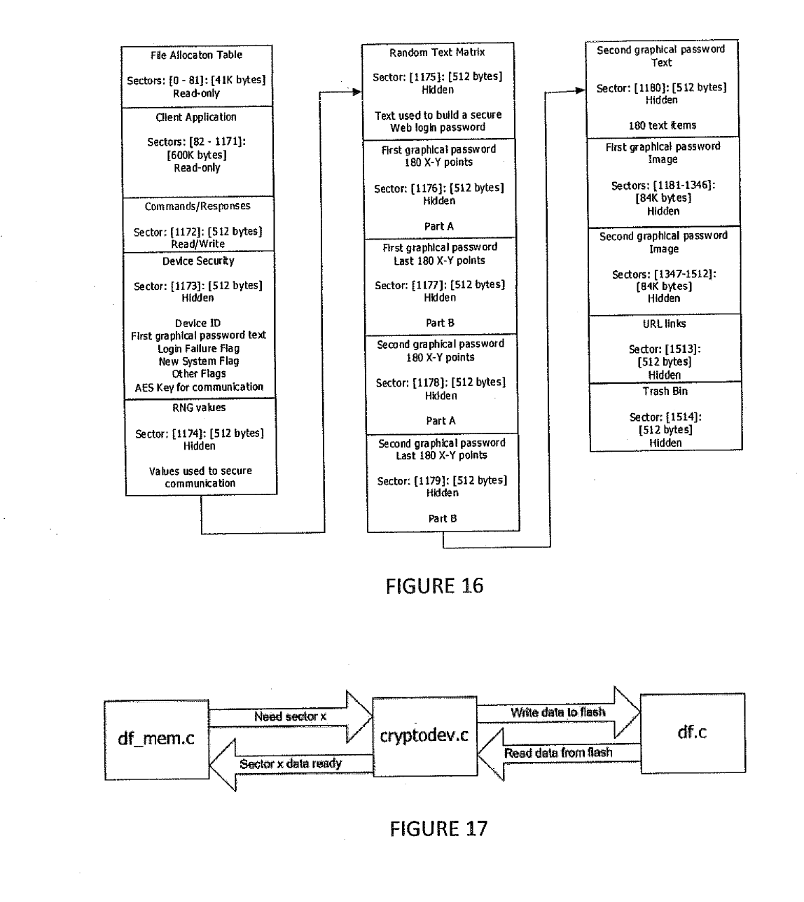

As can be seen from the flash storage map of data (see FIG. 16), there are no passwords for Web logins stored in the device. The only semi-sensitive piece of information is the AES key used for secure communication between the device and the client application. All other data items are specific to assisting the user in creating a Web password; namely, the graphical password image that the user would select their password from. The appendix gives a brief description of each sector and its length. The total usage in this prototype is 775 KB out of 4 MB of flash.

The specific implementation details of one exemplary embodiment are presented as follows. It should be noted that the details provided are for one specific implementation. Other implementations may use other hardware and, as such, would require different commands and implementation details.

In this implementation, an Atmel 8-bit AVR MCU with an on-chip USB controller was selected to simplify design and allow for small circuit size. Atmel was chosen because of plenty of supporting documentation and firmware source code to support fast design and implementation. Additionally, Atmel provided free serial flash memory samples. The constraining requirements of the project were program and data memory size, processor speed, and cost.

An Atmel AT90USB128 8-bit microcontroller with 128K bytes of ISP flash and on-chip USB controller running on an 8 MHz clock was used. The design had a clock frequency of 8 MHz because the data sheet specifies a clock frequency based on Vcc. The AT90USB128 is a RISC CPU with in-system programmable flash. The device was programmed and debugged in circuit with an IEEE 1149.1 standard JTAG interface using an AVR® JTAGICE mkII from Atmel. Firmware was small enough to fit into 64K bytes but 128K ISP flash was used for the design. Programming was accomplished via a 4-pin JTAG port using TCK, TMS, TDI, and TDO on the PF port of the MCU (Table 2). The USB controller was connected to a modified A-male USB connector with the following pin layout, wire color, and MCU connections as described in table 20. The serial peripheral interface bus was used to communicate between the MCU and the flash memory storage as defined in table 21.

TABLE 2
Port F (JTAG programming & debugging)

| PIN | Function |
|---|---|
| PF7 | TDI JTAG Test Data Input |
| PF6 | TDO JTAG Test Data Output |
| PF5 | TMS JTAG Test Mode Select |
| PF4 | TCK JTAG Test Clock |

TABLE 3
USB pin configuration (http://pinouts.ws/usb-pinout.html)

| PIN | Signal | Color | Description | MCU Pin |
|---|---|---|---|---|
| 1 | V_{cc} | Red | +5 V | UVCC, AVCC, DVCC, |
| | | | | UVCON, VBUS, JTAG |
| 2 | D− | White | Data− | D− |
| 3 | D+ | Green | Data+ | D+ |
| 4 | Gnd | Black | Ground | PCB ground plane |

TABLE 4
Port B SPI connection

| PIN | Function |
|---|---|
| PB1 | SCK (SPI Bus Serial Clock or Pin Change Interrupt 1) |
| PB2 | PDI (Programming Data Input or SPI Bus Master |
| | Output/Slave Input or Pin Change Interrupt 2) |
| PB3 | PDO (Programming Data Output or SPI Bus Master |
| | Input/Slave Output or Pin Change Interrupt 3) |
| PB4 | OC2A (Output Compare and PWM Output A for |
| | Timer/Counter2 or Pin Change Interrupt 4) |

Using JTAG, on-chip flash can be verified, programmed, and locked. The MCU can be secured programmatically by setting the correct value in the SPMCSR register to lock or prevent the boot loader and application sections from any software changes. For a test implementation, none of the lock bits were set and the program contents can be easily extracted.

One Atmel AT45 DB321C, 2.7 volt, serial flash memory module was used as the mass storage device. The 34,603,008 bits (4 MB), of memory are organized into 8192 memory pages of 528 bytes each. For this reason, the minimum cluster size for the FAT 32 mass storage was set to 512 bytes for better memory storage efficiency. Because pages of flash memory can hold a cluster of mass storage data, operations such as page-erase, opcode 81H, allows the flash to destroy data quickly. Quick data removal is necessary for tamper detection and data destruction. Though it is possible for data bits to be detected by cryptanalysis methods, data-remanence will be mitigated by applying some periodic bit-flipping of stored bits in data sensitive pages. It may be necessary to design a mechanical means of tamper proofing memory using a metal shield, strong epoxy, and chemical zeroization. In this solution, no passwords are stored in flash memory so cryptanalysis will yield little data.

The Atmel AT90USB128 was configured to use +5 volts from the USB bus to UVCC, AVCC, DVCC, UVCON, VBUS, and JTAG. Though the voltage from the PC's USB port is highly regulated, bypass electrolytic capacitors were used to filter any ripple on Vcc. For bypassing ripple, 100 nF capacitors were placed as near as possible to Vcc. A LP3982 CMOS linear voltage regulator from National Semiconductor was used to provide a regulated +3.3 volts to the SPI bus via port B and the serial flash memory device. The LP3982 is an 8-Pin surface mount device with a 33 nF noise bypass capacitor to stabilize the voltage when the USB device is first plugged in. No debouncing circuitry was used for power-on. When the USB device is plugged into the port, software handles any debouncing. No reset switch was needed because the JTAG programming device can reset the microcontroller. In effect, the circuitry is minimal to reduce cost.

The USB firmware is based on an Atmel mass storage application using SCSI commands developed as part of the AVR273 Application Note. Because most operating systems support mass storage with USB drivers, there would be no need for users to install any software or drivers to support the security token proposed. AVR273 states that the firmware is supported by all Microsoft OS from Windows® 98SE or later, Linux kernel 2.4 or later, and Mac OS 9/x or later. This should satisfy a majority of users.

The firmware is a bundled as part of the USB flash microcontroller software suite with a license to distribute the firmware only as part of an Atmel microcontroller product. For this reason, most of the firmware source was left intact with the addition of one module named cryptodev.c. This prototype module performs all the secure storage and data manipulation as outlined in this document. Cryptodev.c provides a layer between Atmel's firmware and the flash memory device. As such, in the event another microcontroller vendor is needed, this c module could be reused with another firmware bundle and minimal reprogramming. The Atmel module interaction with the prototype is illustrated in FIG. 17.

Table 5 below summarizes the commands/responses and the payload for the device.

| Command | Description |
|---|---|
| DEVICEID | A 16-byte unique value to identify the device to a server. |
| | Additionally, 180 text characters for the login graphical password |
| | are returned. |
| GETTEXT2 | There is no GETTEXT1 because space was used during |
| SAVETEXT1 | the DEVICEID command to send them. As with the the |
| SAVETEXT2 | device login, the Web password requires 180 text |
| | values for the graphical password. |
| GETXY1A | There needs to be X-Y locations for each character |
| GETXY1B | in the graphical password. There are 180 |
| GETXY2A | characters giving 360 values. The order of data is |
| GETXY2B | the x-coordinate followed by the corresponding y- |
| SAVEXY1A | coordinate for each matching character index. |
| SAVEXY1B | Because these values are a short datatype, or two |
| SAVEXY2A | bytes, 720 bytes are needed to transmit all the |
| SAVEXY2B | values. However, the data payload allowed is 498 |
| | bytes. Therefore, two batches of coordinates are |
| | sent or received with 180 X-Y positions at a time. |
| GETIMAGE1 | Two images are used as the background for the |
| GETIMAGE2 | graphical passwords: one for the login and one for |
| SAVEIMAGE1 | the Web password. These images are limited to |
| SAVEIMAGE2 | JPEGs of an allowable size. Since an image will |
| | span many payloads, image saving or retrieval must |
| | be done in repeated sequence. The image size is |
| | stuffed in front of the first payload. A state of |
| | what has been send or received and the image size |
| | determines when the transfer is complete. |
| GETLINKS | The URL that the user considers a favorite for |
| SAVELINKS | secure login can be saved or retrieved. The |
| | “http://www.” part is removed for brevity. An “*” |
| | before the URL means the HTTPS protocal and no “*” |
| | means the HTTP protocol. Each URL is separated by |
| | one white space. |
| CHANGEKEY | The 256-bit, AES key used to encrypt and decrypt |
| | data packets during file I/O is stored in the |
| | device. When the user logs into the device, this |
| | key is used for all sensitive data transmission. |
| GETSAMPLEPTS | The flash memory holds X-Y coordinates determined |
| | by the issuer of the device. These points are sent |
| | to the application to request the pixel color at |
| | those locations. There are 32 points sampled for a |
| | total of 64 values needed. Each value is a short |
| | datatype requiring 128 bytes of payload data. |
| SENDHASHPARTS | Once the user password comprising text, X-Y |
| | positions, and the sample color have been |
| | collected, these items are packaged and sent to |
| | the device so a calculated hash value for the |
| | password can be received. The text is one byte, |
| | the X-Y positions are 4 bytes and the color is 4 |
| | bytes. The maximum space is the payload area. The |
| | first byte of the payload tells the device how |
| | long is the password. From this, the device knows |
| | how long the data is in the payload. |
| GETHASH | If the MCU is finished mathematically computing |
| | the 32-byte value needed as a password, this value |
| | is sent back to the application. |
| GETFILECRC | For security, the portable executable CRC value |
| | for the application is stored in the device. The |
| | application will query this value to validate if |
| | the login was a success. An incorrect CRC should |
| | prevent further communication. |

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”) Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium The medium may be either a tangible medium (e.g., optical or electrical communications lines) or a medium implemented with wireless techniques (e.g., microwave, infrared or other transmission techniques) The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A device for providing access to a restricted resource, the device comprising:
storage means for storing at least one user selected image
processor means for deriving at least one access provision means from a plurality of user selected inputs based on said at least one user selected image, said access provision means being for provision to an access restriction system, said access restriction system providing access to said restricted resource when a correct access provision means is provided to said access restriction system
wherein said access restriction system receives said access provision means through an application interface means for interfacing between said device to said access restriction system.

2. A device according to claim 1 wherein said device is constructed and adapted for coupling to a data processing system.

3. A device according to claim 1 wherein said access provision means is a password

4. A device according to claim 1 wherein said access provision means is an encryption key or alphanumeric password for communicating with said access restriction system.

5. A device according to claim 1 wherein said restricted resource is a website.

6. A device according to claim 1 wherein said restricted resource is a data processing system.

7. A device according to claim 1 wherein said restricted resource is a computer network.

8. A device according to claim 2 wherein said device is coupled to said data processing device through a USB interface.

9. A device according to claim 1 wherein said storage means stores a plurality of user selected images.

10. A device according to claim 9 wherein at least one of said plurality of user selected images is used as a basis for user selected inputs for deriving another access provision means for use in allowing communications between said device and said application interface means.

11. An access provision system for providing an access provision means to an access restriction system, said access restriction system being for controlling access to a restricted resource, the access provision system comprising:
a storage means for storing at least two user selected images and a stored key
an initial image provision means for providing to a user application an initial image from said at least two user selected images
a decryption means for decrypting incoming data transmissions from said user application using said stored key, said incoming data transmissions being encrypted using a key derived from first user input based on said initial user selected image
encryption means for encrypting outgoing data transmissions for transmittal to said user application, said outgoing data transmissions being encrypted using said stored key
subsequent image provision means for providing to said user application at least one subsequent image from said at least two user selected images
derivation means for deriving said access provision means from subsequent user input received from said user application, said subsequent user input being based on said at least one subsequent image
coupling means for coupling said access provision means to said access restriction system through said user application.

12. A system according to claim 11 wherein said access provision means is an encryption/decryption key.

13. A system according to claim 11 wherein said access provision means is a password.

14. A system according to claim 11 wherein at least one of said first user input and said subsequent user input comprises coordinates of a user selected predetermined region on an image.

15. A system according to claim 11 wherein at least one of said first user input and said subsequent user input comprises pixel attributes of a user selected predetermined region on an image.

16. A system according to claim 11 wherein at least one of said first user input and said subsequent user input comprises a predetermined alphanumeric value assigned to a user selected predetermined region on an image.

17. A system according to claim 11 wherein said restricted resource is a computer network.

18. A system according to claim 11 wherein said restricted resource is a data processing system.

19. A system according to claim 11 wherein said restricted resource is a website.

20. A method for providing an access provision means to an access restriction system, the method comprising:
a) receiving a request for at least one initial user selected image from a user application
b) transmitting said at least one initial user selected image to said user application
c) receiving at least one encrypted communication from said user application, said at least one encrypted communication being encrypted using an encryption key derived from user input based on said at least one initial user selected image
d) decrypting said at least one encrypted communication from said user application using a stored encryption key and determining if said at least one encrypted communication is properly encrypted
e) in the event said at least one encrypted communication is not properly encrypted, preventing access by said user application to at least one subsequent user selected image
f) in the event said at least one encrypted communication is properly encrypted,
encrypting subsequent transmissions to said user application using said stored transmission key
decrypting subsequent transmissions from said user application using said stored encryption key, and
receiving a request from said user application for said at least one subsequent user selected image
g) transmitting said at least one subsequent user selected image to said user application
h) receiving user input from said user application, said user input being based on said at least one subsequent user selected image.
i) deriving said access provision means from said user input
j) transmitting said access provision means to said user application.
